(19) United States
(12) Patent Application Publication
(10) Pub. No.: US 2017/0325068 A1
(43) Pub. Date: Nov. 9, 2017

(54) Method and System for Holistic Transportation Routing

(71) Applicant: Leonard Bertelli, Lenox, MA (US)

(72) Inventor: Leonard Bertelli, Lenox, MA (US)

(21) Appl. No.: 15/149,209

(22) Filed: May 9, 2016

(51) Int. Cl. H04W 4/02

(52) U.S. Cl. CPC H04W 4/025; H04W 4/021

(57) ABSTRACT

A method for improving transportation routing offers better performance and greater control over current methods based on injecting domain specific metrics. What is new is the method starts with optimizing small sub-routes from a comprehensive list of all geographic locations that can be routed. This is similar to geometry node contraction but in this case it contracts sub-routes. Every location pair combination is routed and only the best results are saved. These sub-routes are then queried and combined when a user or system provides a set of locations to be routed. What is also new is that this method uses data configurations specific to a type of transportation to enable the optimization to control performance, data size, and routing flexibility.

### STATEMENT REGARDING FEDERALLY SPONSORED RESEARCH OR DEVELOPMENT

This invention was not made with government support. The government has no rights in the invention.

### CROSS-REFERENCE TO RELATED APPLICATIONS

This application claims the benefit of U.S. Provisional Application that was filed 10 May 2015 with application No. 62159293 under the Title “Process for Concurrent Routing”.

### THE NAMES OF THE PARTIES TO A JOINT RESEARCH AGREEMENT

This invention is not part of a joint research agreement. All elements of this invention were developed and are owned by the Inventor of this application (Leonard Bertelli).

### FIELD OF THE INVENTION

The field of the present invention relates to transportation trip planning and more specifically to minimizing computation time and resources needed to provide transportation directions by using preprocessed transit information complete with industry domain data.

### BACKGROUND OF THE INVENTION

This application claims priority from U.S. provisional application 62/159,293 filed May 10, 2015 and relates to a method for optimizing transportation routes. The entire disclosure contained in U.S. provisional application 62/159,293, including the attachments thereto, is incorporated herein by this reference.

Transportation routing methods determine the shortest path between 2 or more geographic locations. Distance and travel time are typically the only criteria that are used to influence the outcome of routing a set of points. The problem with current methods is that they do not take industry and business data into consideration when routing. These methods typically use the Dijkstra or A* routing algorithms and their variations as a basis for determining a route's path.

### SUMMARY OF THE INVENTION

The present invention is a transportation routing method that works with a set of geographic locations specially precompiled for particular domains. For example a domain-based set could consist of all dumpster locations for the waste removal domain. All locations within a domain-based set are compiled into route contraction legs (or sub-routes) optimized for shortest distance, shortest time, and/or knowledge-based data. There are 2 route legs (to and from) for each 2-point combination in the domain-based set. These route legs are selected based on domain metric criteria and then spliced together when a specific set of locations needs to be routed.

Current transportation routing methods take an arbitrary set of geographic locations and calculate a route. Some optimization is done through Node Contraction¹ but this method precompiles a map's geometry into short cut edges for routing any possible combination of locations. This differs from the present invention that is focused on combining precompiled domain specific route legs as opposed to precompiled map geometry. ¹ Robert Geisberger (1 Jul. 2008). Contraction Hierarchies: Faster and Simpler Hierarchical Routing in Road Networks (PDF) (Thesis). Institut für Theoretische Informatik Universität Karlsruhe, Retrieved 2010 Dec. 27.

By routing within a domain, the present invention will improve routing performance and produce appropriate and accurate results where previous methods were generalized. Comprehensive data is taken into consideration to form a holistic approach to determining the best and most appropriate route.

### BRIEF DESCRIPTION OF THE SEVERAL VIEWS OF THE DRAWING

Referring now to the drawings wherein like elements are numbered alike in the several FIGURES:

FIG. 1 illustrates a diagram of locations with exemplary embodiments of how route data is contracted given domain criteria.

FIG. 2 illustrates the data elements that are used to support a holistic routing system.

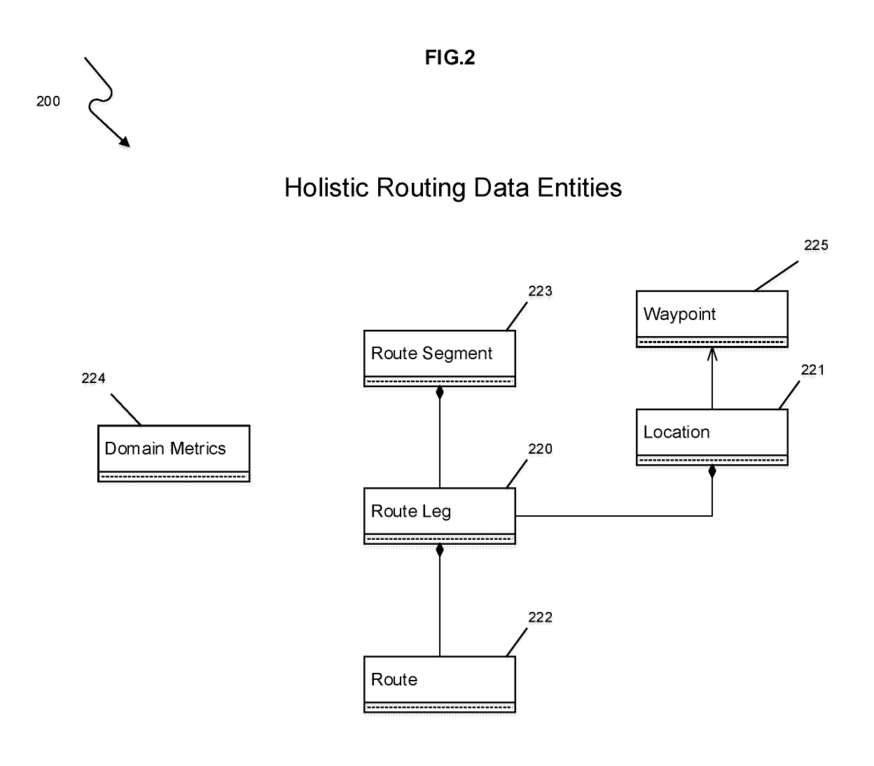

FIG. 3 illustrates a non-limiting example of a table with valid route legs for a waste management vehicle in accordance with exemplary embodiments.

FIG. 4 illustrates a method of querying domain contracted data to create a route.

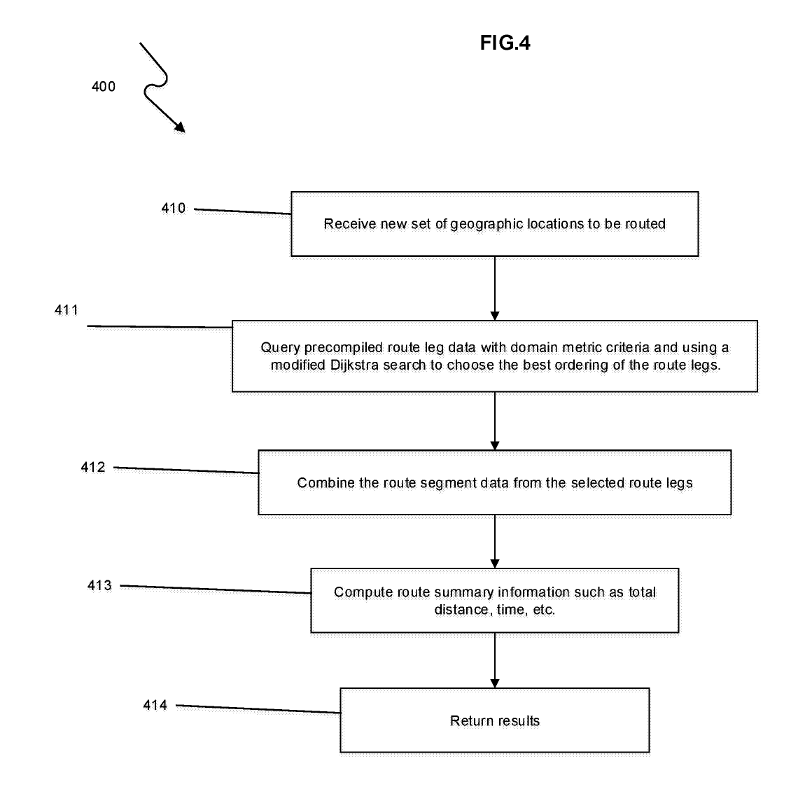

FIG. 5 illustrates a method of contracting and routing optimizing route legs

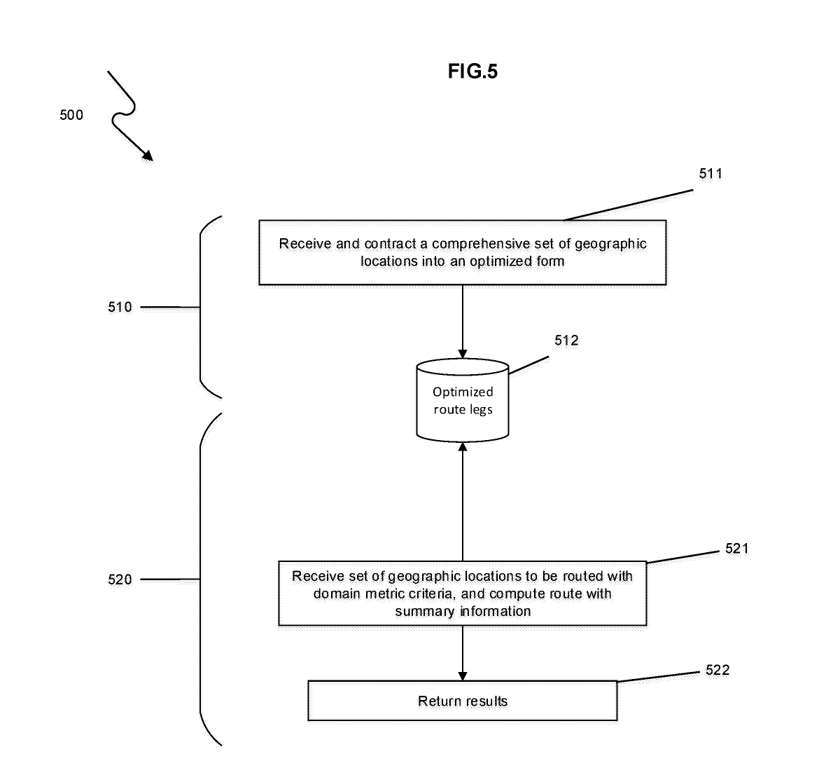

### DETAILED DESCRIPTION

The present invention is a transportation routing method that begins with a predetermined set of geographic locations. These locations are a superset of what may be routed later. This set is then compiled using a special contraction algorithm 120 that reduces the set into an optimized list of location-to-location routes that will be referred to as route legs 220. The route leg contraction 120 511 eliminates unnecessary legs 126 if there are better leg combinations in between. The contraction 120 511 will be done with a modified Dijkstra search. Once the data is compiled it can then be queried to form the best routes.

The present invention works with a predetermined set of geographic locations 221 specially precompiled for particular domains. A domain is the context and data specific to a particular type of business or industry. A location has specific meaning within the context of a domain such as a service location and not a general geographic location. For example a domain-based superset could consist of all dumpster locations for the waste removal domain. All locations 221 within this domain-based set are compiled into route contraction legs (or sub-routes) optimized for shortest distance, shortest time, knowledge-based data such as vehicle constraints and restrictions, and/or any other goal-directed domain metrics 224. There are 2 or more route legs 220 for each 2-point combination in the domain-based set. The multiplicity depends how domain metric 224 criteria is applied during the precompile process 510. At the very least there will be 2 route legs 220 for each 2-point combination representing “to” and “from” route legs 220. An example of where additional route legs 220 may be created is if there are vehicle weight limits and alternate route legs 220 may be added to always provide options during routing later.

Domain metrics 224 can be applied when locations 221 are initially being precompiled 510 to be used as parameters during contraction 120 511 and/or domain metrics 224 can be applied when route legs 220 are being selected during routing 410 510. A user can apply particular domain metric 224 criteria to configure how much flexibility they wish to have the resulting precompiled data 512 be able to query. It is a choice that a user can make to balance trade-offs between precompiled data 511 size, routing performance and query flexibility. An example of this is if certain geographic areas have time restricted noise abatement restrictions for commercial vehicles. The user can either choose to limit the precompiled data into time-restricted data stores 512 and route knowing this or not restrict the precompiled data 511 so that the domain metrics 224 can be applied when routing later. Individual domain metric 224 attributes can be applied in the precompile process 511 to either contract invalid route legs 220 or to include them and alternative route legs 312 315 will be added.

Route legs are selected 411 based on domain metric 224 criteria and then combined together 412 when a specific set 410 of locations needs to be routed 520 521. This creates the resulting route 222 522 with waypoints 225 that are the locations 221 of the combined route legs 220. These results are them summarized 413 and returned 414.

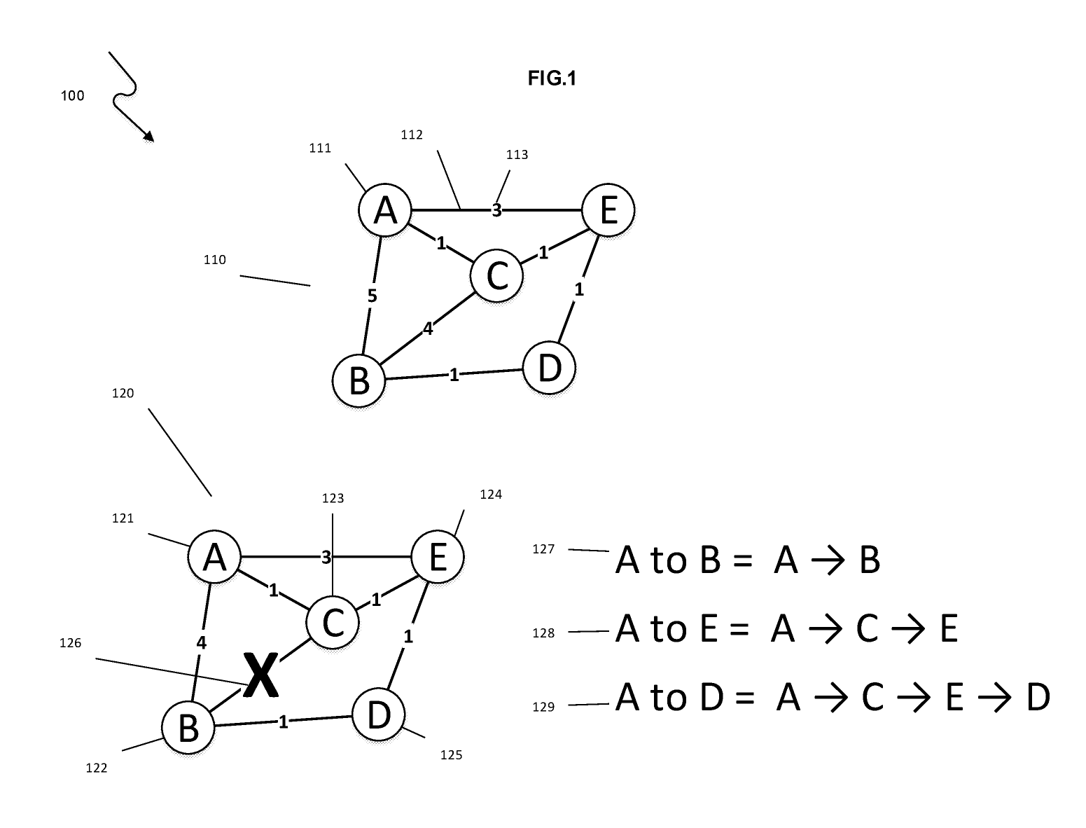

FIG. 1 is a graphical representation of the contraction algorithm eliminating an unnecessary route leg 126. All locations 110 that pertain to a specific domain with the route legs 112 “to” and “from” are maintained with annotations 113 such as distance, time, travel restrictions, etc. that help determine the optimal route leg selection. In this graph a particular leg was eliminated similar to but not limited to Node Contraction §, which is based on eliminating longest distances if there is a better path. Other criteria may be applied, for example, where route legs may be eliminated in order to keep within Gross Vehicle Weight limits (GVWR). The difference is that node contraction eliminates map geometry where its nodes are map elements. The present invention eliminates route legs between locations. An example 120 of routing around a leg elimination 126 shows how route legs are selected for 3 scenarios 127 128 129.

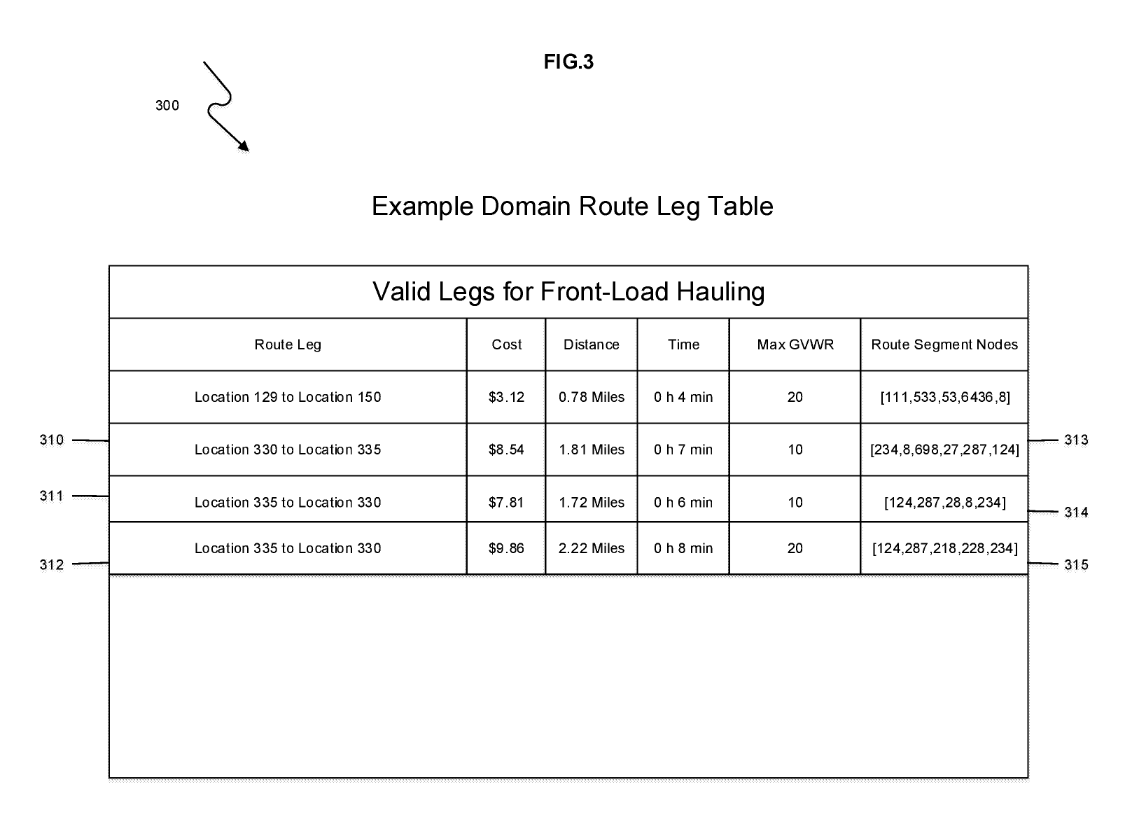

FIG. 3 represents a table 300 of route legs that meet criteria and are valid for the vehicle and other conditions for a domain. This table 300 contains a sample of a dataset of route legs 220. This example is intended to show that route legs between 2 locations 310 311 are not necessarily the inverse of each other because of map geometry limitations such as one way streets, etc. Route leg 312 demonstrates an alternate set of route segments 315 that although is a longer route can still accommodate a heaver vehicle. Each route leg direction 310 311 has a list of its corresponding pre-routed list of segments 313 314 which are in essence the basis for turn-by-turn data which route segments then represent 223.

What is claimed is:

1. A method for producing a contracted list of route legs from a comprehensive set of geographic locations that are optimized for distance and other metrics, the method comprising:
a comprehensive set of geographic locations are all the latitude/longitude positions within a particular domain;
domain specific geographic locations represent all locations where a type of service can be performed and the route legs that can support that type of service;
generating a number of location-to-location route legs with domain data associated with the route legs for subsequent querying;
generating a number of location-to-location route legs with alternate path route legs to avoid constraints identified in domain metrics to be used for subsequent querying;
each location-to-location route leg has a start point, an end point, and turn-by-turn instructions, time, distance, one-way streets, waypoint identifier, direction, alternatives, and driving instructions;
each route leg forms a node in a compaction hierarchy; and
maintaining domain tables to contain all route legs in the compaction hierarchy that are to be subsequently combined to make a complete route.

2. A method for routing a subset of the comprehensive set of locations by using the contracted list of route legs, the method comprising:
a request is an invocation from a communications device to generate a route and contains the information that is used by the method to generate a route;
in response to receiving a request from a communications device, a list of geographical locations that need to be routed together which may include parameterized metrics in the request, that are specific to a particular domain;
the number of the list of geographic locations can be as few as 2 being start-point/end-point to the full set of all geographic locations;
generating a complete route by using the list of geographical locations to search the compaction hierarchy for an optimized result;
an optimized result may be based on but not limited to total time, total distance, or total trip cost based on parameterized metrics in the request;
parameterized metrics provide selection refinement on domain metrics for selection of route legs
a list of more than 2 geographic locations would result in a route that has waypoints;
generating a table to transmit to or make available to a communications device, the user that requested the route, to contain but not limited to a list of route segments with turn-by-turn instructions, time, distance, one-way streets, waypoint identifier, direction, alternatives, and driving instructions; and
generating a route summary to or make available to a communications device, the user that requested the route, to contain but not limited to a total time, total distance, total trip cost based on parameterized metrics in the request, start point, and end point.
